(19) United States
(12) Patent Application Publication
(10) Pub. No.: US 2003/0233582 A1
(43) Pub. Date: Dec. 18, 2003

(54) Methods and apparatus for a computer network firewall which can be configured dynamically via an authentication mechanism

(76) Inventor: Ram Pemmaraju, (US)

Correspondence Address: RAM PEMMARAJU, 8 PONDEROSA LANE, OLD BRIDGE, NJ, 08857, US

(21) Appl. No.: 10/406,208

(22) Filed: Apr. 4, 2003

Related U.S. Application Data
(60) Provisional application No. 60/367,223, filed on Apr. 9, 2002.

(51) Int. Cl. H04L 9/32

(52) U.S. Cl. 713/201; 713/202

(57) ABSTRACT

This invention provides a improved computer network firewall that includes one or more features for increased security. A firewall in accordance with the invention can be configured with rules being added and removed by a firewall controller. Dynamic rules may be used in addition to pre-loaded access rules. A firewall client on a user's computer is used to “logon” to the firewall controller and after being authenticated by it, can access the firewall.

### CROSS-REFERENCE TO RELATED APPLICATIONS

Provisional patent application No. 60/367,223 Filing date Apr. 9, 2002

### BACKGROUND OF THE INVENTION

1. Field of the Invention

This invention relates to the prevention of unauthorized access in computer networks and, more particularly, to firewall protection within computer networks.

2. Background of the Invention

In computer networks, information is conventionally transmitted in the form of packets. Information present at one site may be accessed by or transmitted to another site at the command of the former or the latter. Thus if information is proprietary, there is a need for safeguards against unauthorized access. To this end, techniques known as packet filtering effected at a network processor component known as a firewall, have been developed and commercialized. At the firewall, packets are inspected and filtered, i.e., passed on or dropped depending on whether they conform to a set of predefined access rules. Typically, a firewall administrator allows broad access that is consented to from one side of the firewall to the other, but blocks transmissions in the opposite direction that are not part of an active network session. For example, “inside” company employees may have unrestricted access through the firewall to an “outside” network such as the Internet, but access from the Internet is blocked unless it has been specifically authorized. There are two types of firewalls—Perimeter firewalls and Host-resident firewalls.

Perimeter firewalls sit between the “unfriendly” network, i.e., the Internet, and the “friendly” enterprise network. These provide a security gateway between the two environments, inspecting and filtering all incoming and outgoing data traffic at a single checkpoint.

Host-resident firewalls are host-resident security software applications that protect the enterprise network's critical endpoints against unwanted intrusion. Usually deployed behind the perimeter firewall, they provide a second layer of defense. They work by enabling only essential traffic into the machine they protect, prohibiting other types of traffic to prevent unwanted intrusions. Whereas the perimeter firewall must take a generalist, common denominator approach to protecting servers on the network, Host-resident firewalls act as specialists. They offer the advantage of filtering traffic from both the Internet and the internal network. This enables them to prevent hacking attacks that originate from both the Internet and the internal network. This is important because the most costly and destructive attacks still originate from with the organization.

3. Problems with Current Firewalls

The problem with both the above firewalls is that they can filter only statically assigned IP addresses. A Perimeter Firewall can filter traffic between the external network and the internal network. If the firewall is breached, the computers on the internal network are unprotected. Host-resident firewalls solve this problem by placing a firewall on the computer itself. However, the firewall can only be configured to filter out traffic from the outside network. It suffers from the same security problems as a Perimeter Firewall and can also be breached.

The solution is to allow access only from selected computers within the internal network. The problem with this is that the computers in the internal network have their IP addresses assigned dynamically, i.e. it changes every time the computer is booted up.

In preparing for this application, a review of various patent resources was conducted. The review resulted in the inventor gaining familiarity with the following patents:

| PAT. NO. | INVENTOR | ORIG. CLASS | ISSUE DATE |
|---|---|---|---|
| 6,442,588 | Clark et al. | 709/203 | Aug. 27, 2002 |
| 6,353,856 | Kanemaki et al. | 709/229 | Mar. 5, 2002 |
| 5,950,195 | Stockwell et al. | 704/229 | Sep. 7, 1999 |
| 6,519,703 | Joyce et al. | 713/201 | Feb. 11, 2003 |
| 6,052,788 | Wesinger et al. | 713/201 | Apr. 18, 2000 |

### SUMMARY OF THE INVENTION

The present invention, hereinafter referred to as NetFirewall, provides techniques for implementing computer network firewalls so as to improve security by allowing access only from selected computers within the internal network.

In accordance with a first aspect of the invention, NetFirewall is able to support a firewall with a client-server architecture.

In accordance with a second aspect of the invention, NetFirewall can be configured to handle dynamic IP addresses as well as static IP addresses.

In accordance with a third aspect of the invention, NetFirewall can be configured to provide authenticated access to a firewall.

In accordance with a fourth aspect of the invention, NetFirewall can be configured to provide “Single Sign-On” access to multiple firewalls.

In accordance with a fifth aspect of the invention, NetFirewall can be configured to encrypt packets between two firewalls.

### BRIEF DESCRIPTION OF THE DRAWINGS

FIG. 1 is a schematic of a perimeter firewall providing security to the corporate network from the Internet.

FIG. 2 is a schematic of the NetFirewall system within a corporate network.

FIG. 3 is a flowchart of the NetFirewall logon process.

FIG. 4 is a flowchart of the NetFirewall logoff process.

### DESCRIPTION OF THE INVENTION INCLUDING PREFERRED EMBODIMENTS

The preferred techniques can be implemented at a firewall for controlling the flow of data between, for example, separate local area networks (LANs) or subnets of a LAN. Exemplary embodiments of the invention are described herein in terms of processes. Efficient prototypes of such processes have been implemented as computer system software, for implementation on general-purpose PC hardware. Efficiency can be enhanced further, as is known, by special-purpose firmware or hardware computer system implementations.

1. Firewall with a Client-server Architecture

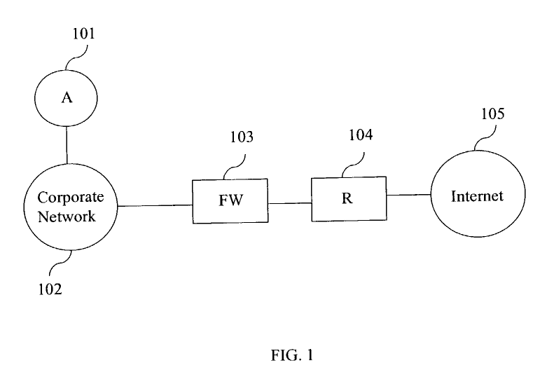

Existing firewalls are implemented in a server-only architecture. This is illustrated in FIG. 1 which shows a perimeter firewall 103 protecting a corporate network 102 and a computer on it 101. The perimeter firewall 103 is connected to the Internet 105 via a router 104.

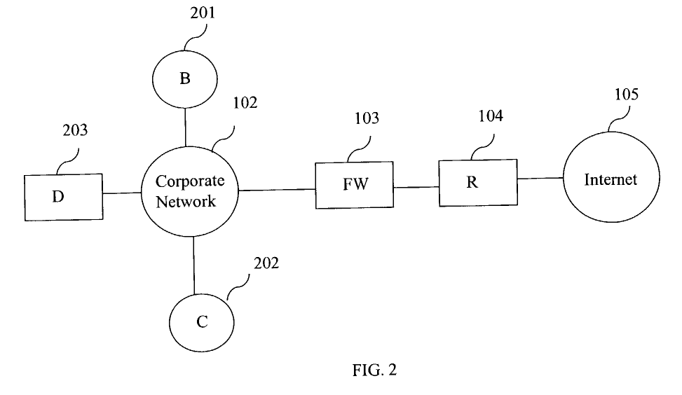

FIG. 2 depicts the NetFirewall architecture. The client-side component “NetFirewall Client” is resident in a user computer B 201. The server-side component “NetFirewall Server” is resident on a server computer C 202. The “NetFirewall Controller” D 203 controls access between B 201 and C 202.

2. Handling Dynamic as Well as Static IP Addresses

Existing firewalls have rules that control access between networks (in the case of a perimeter firewall) or between a network and a computer (in the case of a host-resident firewall). In either case, the rules are based on statically assigned IP addresses. These rules are programmed by a firewall administrator. Like existing firewalls, NetFirewall can have the rules based on statically defined IP addresses that are programmed by a firewall administrator.

Unlike existing firewalls, NetFirewall can also have the rules based on dynamically assigned IP addresses that are programmed by the client-side component of NetFirewall via the NetFirewall Controller using an authentication mechanism.

3.Authenticated Access to a Firewall

Existing firewalls do not have authenticated access. The access is controlled by a set of static rules defined by the firewall administrator. Once the rules are defined, any computer within the authorized network has access via the firewall at any time.

Unlike existing firewalls, NetFirewall can have dynamic rules which are programmed by the NetFirewall Client via the NetFirewall Controller using an authentication mechanism. A user can “logon” to the firewall and “logoff” from the firewall.

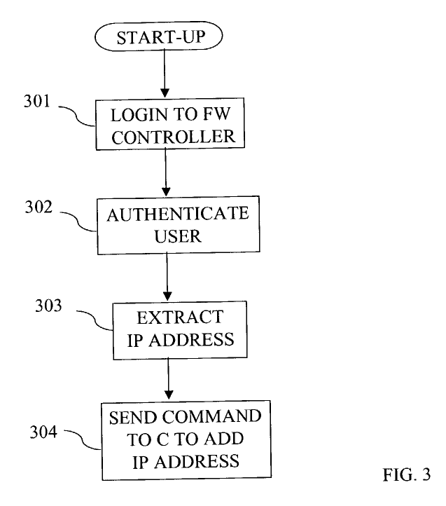

FIG. 3 is a flowchart of the NetFirewall logon process. The following steps are included:

301: A user invokes the NetFirewall Client software on their computer. A box is displayed prompting the user to enter a username and a password. After the information is entered, the user clicks a button labeled “Logon”. The information is sent to the NetFirewall Controller in encrypted form.

302: The NetFirewall Controller validates the username and password against data stored in its internal database. If the validation is successful, further processing occurs.

303: The NetFirewall Controller extracts the dynamically assigned IP address of the user's computer from the logon message and checks whether it originates from a computer within the authorized network. If the validation is successful, further processing occurs.

304: The NetFirewall Controller sends the IP address of the user's computer to the NetFirewall Server. The information exchange between the NetFirewall Controller and NetFirewall Server is sent in encrypted form after mutual authentication. The NetFirewall Server adds the IP address of the user's computer to its rule table.

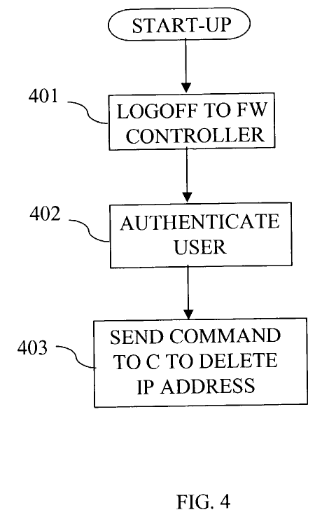

FIG. 4 is a flowchart of the NetFirewall logoff process. The following steps are included:

401: A user invokes the NetFirewall Client software on their computer. A box is displayed prompting the user to enter a username and a password. After the information is entered, the user clicks a button labeled “Logoff”. The information is sent to the NetFirewall Controller in encrypted form.

402: The NetFirewall Controller validates the username and password against data stored in its internal database. If the validation is successful, further processing occurs.

403: The NetFirewall Controller sends the IP address of the user's computer to the NetFirewall Server. The information exchange between the NetFirewall Controller and NetFirewall Server is sent in encrypted form after mutual authentication. The NetFirewall Server deletes the IP address of the user's computer from its rule table.

The logoff process can happen without the intervention of the NetFirewall Client based upon adminstrator criteria, such as time-of-day. For example, the administrator can program the NetFirewall Controller to logoff all users from 6.00 pm till 8.00 am.

4. Single Sign-On Access to Multiple Firewalls

The NetFirewall Controller can have a list of server computers (which have the NetFirewall Server) a given user can access. This list can be customizable per user. After the user login process, the NetFirewall Server programming step (see 304 above) can be done for all the server computers on the user list.

5.Packet Encryption Between Two Firewalls

The NetFirewall Controller can act as a key distribution center and distribute session encryption keys between the NetFirewall Client and the NetFirewall Server. These keys can be used to encrypt data between the NetFirewall Client and the NetFirewall Server.

What is claimed is:

1. A computer network firewall which can be configured dynamically via a firewall controller, the configuration initiated by a user logging on and authenticating to the firewall controller, said computer network firewall comprising:
a server-side firewall component;
a client-side component that resides on the user's computer initiates the logon process to the firewall;
a controller component that authenticates the user and configures the firewall;

2. A computer network firewall as described in claim 1 wherein: said server-side component is a host-based firewall; said client-side component resides on a computer running the Windows operating system; and, said controller component resides on a server with either a Windows, Linux or UNIX OS.

3. A computer network firewall as described in claim 1 wherein: said controller component authenticates the user via an in-band authentication mechanism (where the user id and password is sent in the same path) using any password scheme including but not limited to unencrypted password (PAP), encrypted password (CHAP), hardware and software tokens, digital certificates using PKI, smart cards or biometric mechanisms.

4. A computer network firewall as described in claim 1 wherein: said controller component authenticates the user via an out-of-band authentication mechanism (where the user id and password is sent on separate paths or networks) using any password scheme including but not limited to unencrypted password (PAP), encrypted password (CHAP), hardware and software tokens, digital certificates using PKI, smart cards or biometric mechanisms.

5. A computer network firewall as described in claim 1 wherein: said controller component configures the access rules of either a host-resident or a perimeter firewall.

6. A computer network firewall as described in claim 5 wherein: the access rules allow either any computer on a sub-network (for example, any computer on sub-network, 192.168.1.X is allowed access) or a specific computer (for example, a computer with an IP address of 192.168.1.3 is allowed access) to be configured.

7. A computer network firewall as described in claim 1 wherein: said server-side component can be either a host-resident or a perimeter firewall.

8. A computer network firewall as described in claim 1 wherein: said client-side component resides on a computer with either a Windows, Linux or UNIX OS.

9. A computer network firewall as described in claim 1 wherein: said controller component can act as a key distribution center and distribute session encryption keys between the client-side component and the server-side component.

9. A computer network firewall as described in claim 1 wherein: said controller component can configure multiple server-side components (single sign-on) during a user initiated firewall logon session.
